(19) United States
(12) Patent Application Publication
(10) Pub. No.: US 2024/0191773 A1
(43) Pub. Date: Jun. 13, 2024

(54) SHOCK ABSORBER AND METAL COVER

(71) Applicant: Sanwa Packing Industry CO., LTD., Osaka (JP)

(72) Inventors: Yasuyuki NAKANO, Osaka (JP); Kenji NAGASAKI, Osaka (JP)

(21) Appl. No.: 18/581,600

(22) Filed: Feb. 20, 2024

Related U.S. Application Data
(63) Continuation-in-part of application No. 16/961,884, filed on Jul. 13, 2020, now abandoned.

(51) Int. Cl. F16F 15/02; F16F 1/34

(52) U.S. Cl. CPC F16F 15/02; F16F 1/34

(57) ABSTRACT

A shock absorber and a metal cover reduce contact noise generated as a shock absorbing member hits a collar and have higher vibration damping performance. A shock absorber absorbing vibration to a heat insulator covering an exhaust manifold as a vibration source includes a collar, a grommet, an annular compression mesh including a shock absorbing material, and a spiral spring overlaid on a compression mesh. The compression mesh has a center hole loosely receiving a collar shaft. The spiral spring spiral in a plan view has a spring constant equal to or smaller than that of the compression mesh. The compression mesh includes a restriction ridge along a lower large-diameter portion to restrict radial movement of the spiral spring relative to the compression mesh. The circumferential contact area X of the lower large-diameter portion with the restriction ridge ranges between 40% and 55%.

### BACKGROUND OF INVENTION

### Field of the Invention

The present invention relates to a shock absorber used at, for example, a connection between a heat insulator and an exhaust manifold included in an internal-combustion engine, and to a metal cover such as a heat insulator having a shock absorber.

### Background Art

A known exhaust manifold, which allows passage of combustion exhaust gas from an engine, is covered with a heat insulator to reduce heat transfer from the passing exhaust gas to the surroundings. The exhaust manifold generates heat, as well as vibration noise as the engine vibrates or the pulsing exhaust gas passes.

A heat insulator (hereafter, a covering member) directly connected to an exhaust manifold (hereafter, a vibration member) may resonate with the vibration member and be a vibration source, and may increase such vibration noise. Patent Literature 1 describes, for example, a shock absorber used at a connection between a vibration member and a covering member.

The shock absorber described in Patent Literature 1 includes an annular shock absorbing member between a fixing member fixable to the covering member and a collar fixable to the vibration member with a fastener, such as a fastening bolt.

In the shock absorber, the shock absorbing member is fixed to the fixing member while loosely fitted on the collar with a clearance. This structure reduces transmission of the vibration applied from the vibration member to the shock absorbing member through the collar, and thus has high vibration damping performance.

However, the clearance left between the collar and the shock absorbing member to improve vibration damping performance may allow the shock absorbing member to move relative to the collar under vibration from the vibration member and generate rattling noise as the shock absorbing member hits the collar. Such noise may sound unusual for occupants in vehicles that are quieter than engine-driven vehicles, including recently popular hybrid vehicles in a motor driving mode or electric vehicles.

Patent Literature 2 describes a shock absorber including a collar fixable to an exhaust manifold with a fastening bolt, an annular fixing member fixable to a covering member, an annular compression mesh located between the collar and an insulator base with its inner peripheral portion loosely fitted on the collar and formed from a shock absorbing material including metal wires knitted together, and a spiral spring overlaid on the compression mesh between the collar and the compression mesh to serve as a shock absorbing component that reduces movement of the compression mesh relative to the collar.

The shock absorber described in Patent Literature 2 with the above structure has stable high vibration damping performance while reducing contact noise generated as the compression mesh hits the collar.

Shock absorbers may further improve shock absorbing performance or vibration damping performance for recent vehicles that are more sophisticated and operate more quietly. However, the shock absorber described in Patent Literature 2, which can reduce contact noise between the compression mesh and the collar, cannot improve vibration damping performance further.

### CITATION LIST

### Patent Literature

Patent Literature 1: Japanese Unexamined Patent Application Publication No. 2004-360496
Patent Literature 2: Japanese Unexamined Patent Application Publication No. 2017-219069

### SUMMARY OF INVENTION

### Technical Problem

One or more aspects of the present invention are directed to a shock absorber that reduces contact noise generated as the shock absorbing member hits the collar and has higher vibration damping performance, and a metal cover having the shock absorber.

### Solution to Problem

A shock absorber according to one aspect of the present invention is a shock absorber for connecting a vibration member as a vibration source and a covering member for covering the vibration member to absorb vibration from the vibration member to the covering member. The shock absorber includes a collar including a substantially tubular collar shaft to be fastened to the vibration member with a fastener, and annular flanges protruding radially outward from two axial ends of the collar shaft, an annular fixing member fixable to the covering member, an annular shock absorbing member located between the collar and the fixing member with a radially outer peripheral portion of the shock absorbing member fixed to the fixing member and including a shock absorbing material, and a spring located between at least one of the flanges on the collar and the shock absorbing member, and overlaid on the shock absorbing member.

The shock absorbing member includes a radially inner peripheral portion which located a radially inward part of the shock absorbing member loosely fitted on the collar shaft at least in a radial direction. The spring has a spring constant equal to or smaller than a spring constant of the shock absorbing member, and is substantially truncated in a side view which has a larger diameter in a portion nearer the shock absorbing member than in a portion nearer the at least one of the flanges, and is spiral in a plan view. The radially inner peripheral portion of the shock absorbing member is thicker than the radially outer peripheral portion fixed to the fixing member. The shock absorbing member includes a movement restrictor in contact with the spring to restrict radial movement of the spring relative to the shock absorbing member. The movement restrictor locates between the radially inner peripheral portion and the radially outer peripheral portion, and is adjacent to the spring on the shock absorbing member. The movement restrictor includes a movement restriction ridge protruding to outwardly more than the radially inner peripheral portion, and extends along and is in contact with the radially outer portion that is radially outward in the spring spiral in a plan view. The spring has the radially outer portion in contact with 40% to 55% of a circumference of the movement restrictor.

The metal wires include a metal material having various functions and properties, such as wires formed from stainless steel, tungsten, molybdenum, aluminum, iron, nickel, or copper, and wires formed from an iron-aluminum alloy capable of vibration damping.

The axial direction is aligned with the thickness direction of the shock absorbing member and the spring.

The shock absorbing member including the radially inner peripheral portion loosely fitted on the collar shaft at least in the radial direction refers to having the radially inner peripheral portion loosely fitted in the radial direction alone or loosely fitted in both the radial direction and the axial direction.

The shock absorbing material includes, for example, a spring or a mesh member including wires knitted together. The spring and the mesh member are elastically deformable, or for example, bendable in the thickness direction, compressible in the thickness direction, stretchable in the plane direction, or deformable in a manner combining these deformations. The plane direction refers to the direction orthogonal to the thickness direction.

The movement restrictor may be a part of the shock absorbing member or may be separate from the shock absorbing member.

The movement restrictor extending along and in contact with the radially outer portion that is radially outward refers to the movement restrictor in contact with the radially outer portion, and also the movement restrictor slightly apart from the radially outer portion to immediately come in contact with the radially outer portion under an external force applied radially. The movement restrictor extending along the radially outer portion refers to the movement restrictor extending continuously along the radially outer portion or multiple movement restrictors arranged at predetermined intervals on the radially outer portion.

The movement restrictor extending along and in contact with the radially outer portion that is radially outward may be circular in a plan view and have at least a predetermined area of its circumference in contact with the radially outward area spiral in a plan view, or may be spiral with a variable curvature, in accordance with the radially outward area spiral in a plan view.

The structure according to the above aspect of the present invention reduces contact noise generated as the shock absorbing member hits the collar and has higher vibration damping performance.

In detail, the annular shock absorbing member located between the collar and the fixing member with the radially outer peripheral portion fixed to the fixing member and including a shock absorbing material is axially bendable and thus deforms elastically. This reduces the vibration from the vibration member transmitted to the fixing member through the collar, thus reducing the vibration from the vibration member propagating to the covering member, or in other words, absorbing such vibration.

The radially inner peripheral portion of the shock absorbing member is loosely fitted on the collar shaft at least in the radial direction. The shock absorbing member thus moves at least radially relative to the collar that vibrates as the vibration member vibrates. This structure can damp vibration, and reduces vibration propagating to the shock absorbing member.

The spring located between one of the flanges on the collar and the shock absorbing member and overlaid on the shock absorbing member has a smaller spring constant than the shock absorbing member. The elastically deformable spring thus absorbs at least radial movement of the shock absorbing member relative to the vibrating collar as described above. This reduces contact noise generated as the shock absorbing member moves relative to the collar under vibration propagating to the collar, without lowering the shock absorbing performance of the shock absorbing member.

The spring is spiral in a plan view, and the movement restrictor may extend along and be in contact with the radially outer portion that is radially outward in the spring spiral in a plan view.

The structure provides further damping with friction between the movement restrictor and the radially outer portion, in addition to damping with the spring. The shock absorber can thus further damp input vibration, providing high vibration damping performance.

In detail, the spring, which is spiral in a plan view and has the radially outer portion with the variable curvature, cannot be in contact with one turn along the entire circumference of the movement restrictor circular in a plan view and has a constant curvature. As described above, this structure including the radially outer portion in contact with 40% to 55% of the circumference of the movement restrictor provides further damping with friction between the movement restrictor and the radially outer portion, in addition to damping with the spring. The shock absorber can thus further damp input vibration, providing high vibration damping performance.

The spring is substantially truncated in a side view, and have a larger diameter in a portion nearer the shock absorbing member than in a portion nearer the at least one of the flanges.

The spring with this structure axially compresses by a greater degree than a coil spring having the same diameter from the upper to lower ends. This structure provides space for movement of the shock absorbing member relative to the collar for deforming elastically and absorbing vibration, and reliably prevents the shock absorbing member from lowering the absorbing performance.

The structure also prevents wire portions included in the spring from coming in contact with each other when the spring, which is spiral in a plan view and truncated in a side view, compresses under a load.

Whereas a spring substantially truncated in a side view and having a smaller diameter in a portion nearer a shock absorbing member than in a portion nearer a flange may have an unstable posture with respect to the shock absorbing member, a truncated spring having a larger diameter in a portion nearer a shock absorbing member than in a portion nearer a flange can have a stable posture with respect to the shock absorbing member, and can stably have friction that improves damping when the movement restrictor rubs against the larger-diameter spring.

The movement restrictor is adjacent to the spring on the shock absorbing member, and include a movement restriction ridge having an outwardly-curved cross section.

The movement restrictor with the above structure is formed easily, and can further damp vibration with friction with the radially outer portion of the spring.

In detail, the movement restrictor is adjacent to the spring on the shock absorbing member, and includes a movement restriction ridge having an outwardly-curved cross section. The structure reliably prevents radial movement of the spring relative to the shock absorbing member, and easily forms the movement restrictor that reliably comes in contact with the radially outer portion and cause intended friction. The resultant shock absorber has increased damping, or has high vibration damping performance.

The shock absorbing member including metal wires knitted together can increase friction between the movement restriction ridge and the radially outer portion. The resultant shock absorber increases damping and has higher vibration damping performance.

In the shock absorbing member, the radially inner peripheral portion is thicker than the radially outer peripheral portion fixed to the fixing member, and the movement restrictor locates between the radially inner peripheral portion and the radially outer peripheral portion. In this structure, the radially outer peripheral portion is more deformable than the radially inner peripheral portion in response to input vibration to the shock absorbing member. Thus the shock absorbing member can suppress the deformation of the movement restrictor, if the vibration is input.

The shock absorbing member includes the movement restrictor in contact with the spring. The radially outer portion is in contact with 40% to 55% of the circumference of the movement restrictor. In this structure, friction between the movement restrictor and the radially outer portion further damps vibration input to the shock absorber, in addition to damping with the spring.

A structure including the spring in contact with less than 40% of the circumference of the movement restrictor cannot have such friction between the movement restrictor and the spring that allows damping described above, and may have substantially the same damping as obtained with the spring fixed to the shock absorbing member, or in other words, damping with the spring alone.

As described above, the structure including the spring in contact with 40% to 55% of the circumference of the movement restrictor provides further damping with friction between the movement restrictor and the radially outer portion, in addition to damping with the spring. The shock absorber can thus further damp input vibration, providing high vibration damping performance.

As described above, the radially inner peripheral portion is thicker than the radially outer peripheral portion fixed to the fixing member, and the movement restrictor locates between the radially inner peripheral portion and the radially outer peripheral portion. The structure provides the suppression of the deformation of the movement restrictor by input vibration. Thus the shock absorber provides more further damping with friction between the movement restrictor and the radially outer portion, in addition to damping with the spring.

The spring may be in contact with 45% to 55% of the circumference of the movement restrictor.

In another aspect of the present invention, the thickness of the radially inner peripheral portion may be twice of the one of radially outer peripheral portion fixed to the fixing member.

In this structure, the radially outer peripheral portion can be more reliably deformed than the radially inner peripheral portion in response to input vibration to the shock absorbing member. The radially outer peripheral portion is located the radially inward part of the shock absorbing member.

In another aspect of the present invention, the movement restriction ridge in contact with the radially outer portion located radially outward of the spring is an outwardly-curved cross section.

In this structure, a contact area of the movement restriction and the radially outer portion increases, and the shock absorber provides more further damping with friction between the movement restrictor and the radially outer portion.

In another aspect of the present invention, the spring substantially truncated in a side view may have a height greater than a distance between the shock absorbing member in contact with one of the flanges on the two axial ends and another of the flanges.

In the shock absorber with the above structure, the spring is attached in a manner compressed against the axial urging force, or in other words, the spring is attached in a prestressed manner. The spring thus reliably reduces contact noise generated as the shock absorbing member hits the collar, and increases friction between the spring and the movement restrictor in contact with each other, thus further improving damping of the shock absorber.

A metal cover according to another aspect of the present invention includes the above shock absorber attached to a covering member for covering a vibration member.

The shock absorber absorbs vibration from the vibration member. The metal cover thus does not become a vibration source by resonating with the vibration member. The metal cover improves damping and has high vibration damping performance while reducing contact noise between the shock absorbing member and the collar.

### Advantageous Effects

The shock absorber and the metal cover having the shock absorber according to the above aspects of the present invention reduce contact noise generated as the shock absorbing member hits the collar and have higher vibration damping performance.

### BRIEF DESCRIPTION OF THE DRAWINGS

FIG. 1 is a schematic perspective view of a shock absorber.

FIG. 2 is a schematic cross-sectional view of the shock absorber.

FIG. 3 is an exploded perspective view of the shock absorber.

FIG. 4 is a view of a compression mesh.

FIG. 5 is a horizontal cross-sectional view of the shock absorber.

FIG. 6 is an enlarged partial perspective view of an insulator base with the shock absorber and a schematic perspective view of a heat insulator before being shaped.

FIG. 7 is a schematic front view of a shock absorber-attached heat insulator mounted on an engine.

FIG. 8 is a schematic cross-sectional view of the shock absorber attached.

FIG. 9 is a view of the shock absorber describing the operation.

FIG. 10 is a view of a tensile test.

FIG. 11 is a view of a damping member model.

FIG. 12 is a view of a simulation result.

FIG. 13 is a view of shock absorbers used in damping evaluation tests.

FIG. 14 is a view of shock absorbers used in damping evaluation tests.

FIG. 15 is a view of shock absorbers used in damping evaluation tests.

FIG. 16 is a photograph of shock absorbers showing the damping evaluation test conditions.

### DETAILED DESCRIPTION

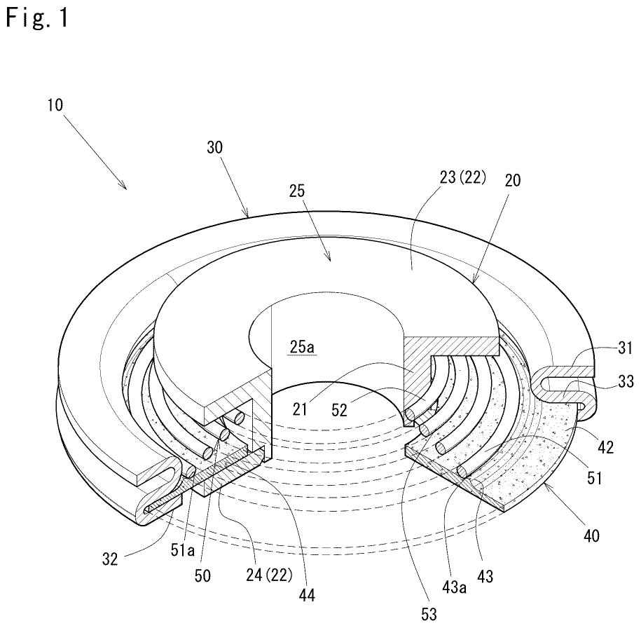

A shock absorber 10 according to one or more embodiments of the present invention and its damping will be described with reference to FIGS. 1 to 16.

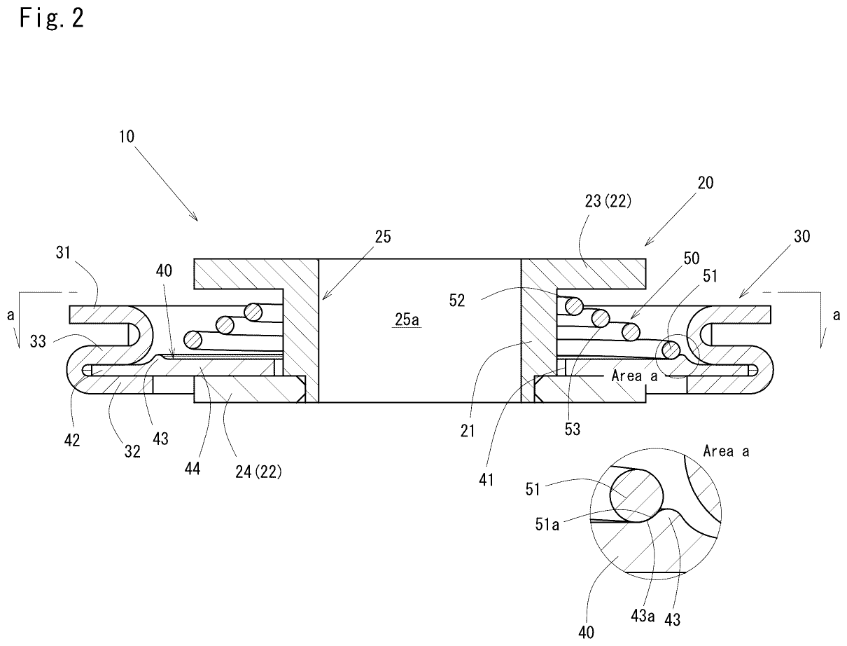

FIG. 1 is a schematic perspective view of the shock absorber 10. FIG. 2 is a schematic vertical cross-sectional view of the shock absorber 10. In FIG. 1, front parts of the components of the shock absorber 10 are cut away to show the internal structure of the shock absorber 10. In the figure, a collar 20 and a grommet 30 are cut away by larger parts than a compression mesh 40 and a spiral spring 50.

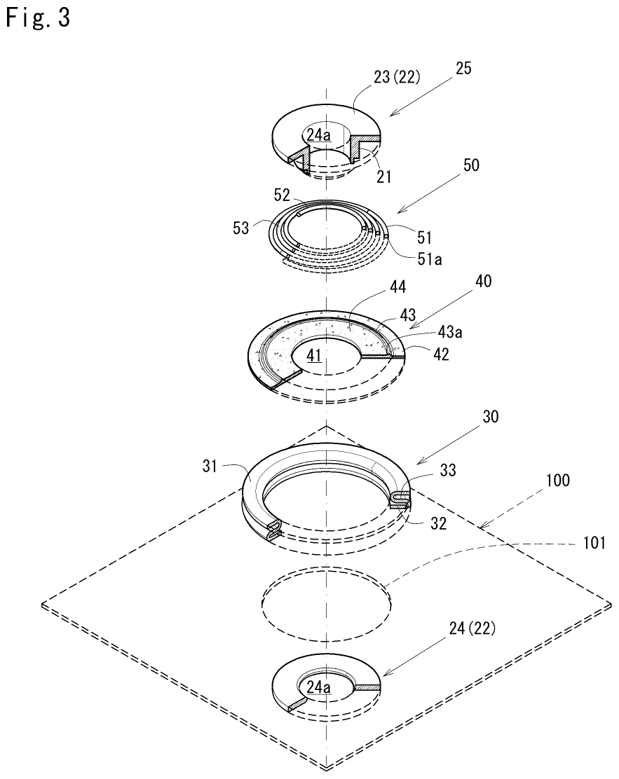

FIG. 3 is an exploded perspective view of the shock absorber 10. In FIG. 3, front parts of the components of the shock absorber 10 are cut away to show the internal structure of the shock absorber 10. For easy understanding of the shock absorber 10 being attached, the dash-dot lines in FIG. 3 indicate an insulator base 100 that receives the shock absorber 10.

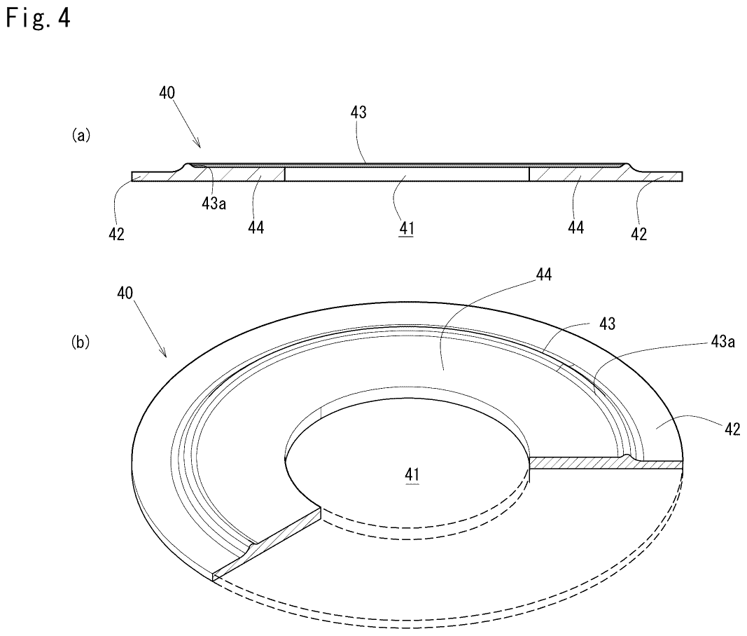

FIG. 4 is a view of the compression mesh 40. In detail, FIG. 4(a) is cross-sectional view of the compression mesh 40 at a center. FIG. 4(b) is a perspective view of the compression mesh 40. In FIG. 4(b), front parts of the components of the compression mesh 40 are cut away to show the internal structure of the compression mesh 40.

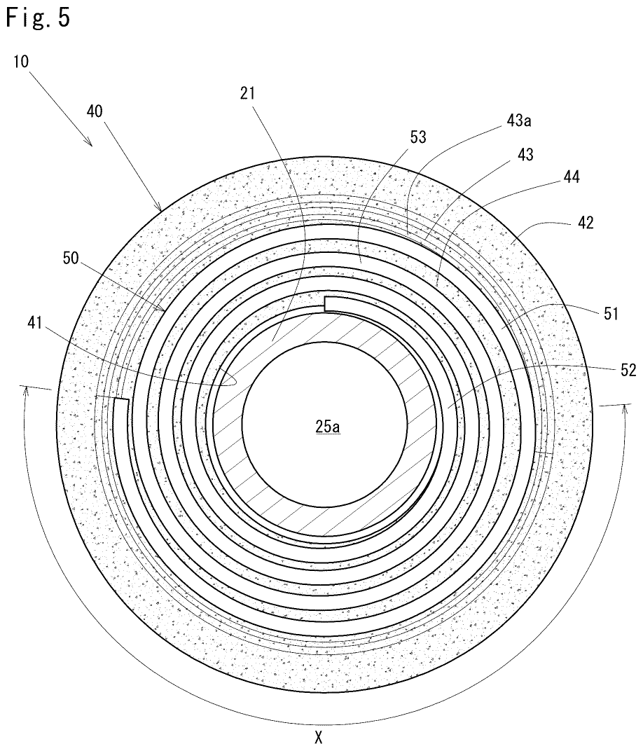

FIG. 5 is a horizontal cross-sectional view of the shock absorber 10. In detail, FIG. 5 is a cross-sectional view in the direction indicated by arrows along line a-a in FIG. 2 without showing the grommet 30.

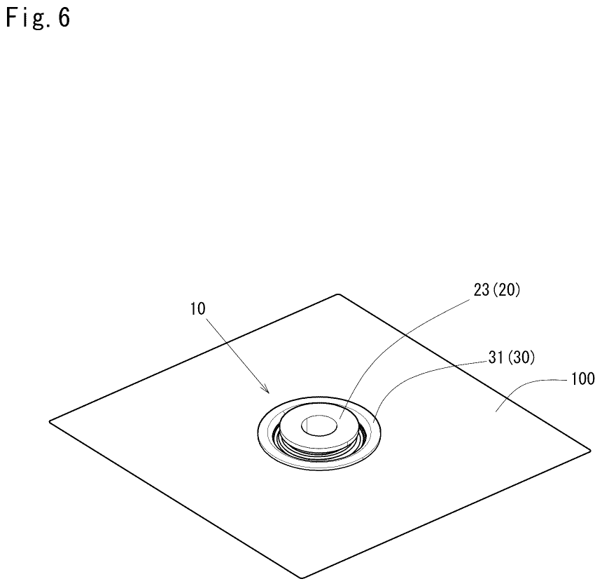

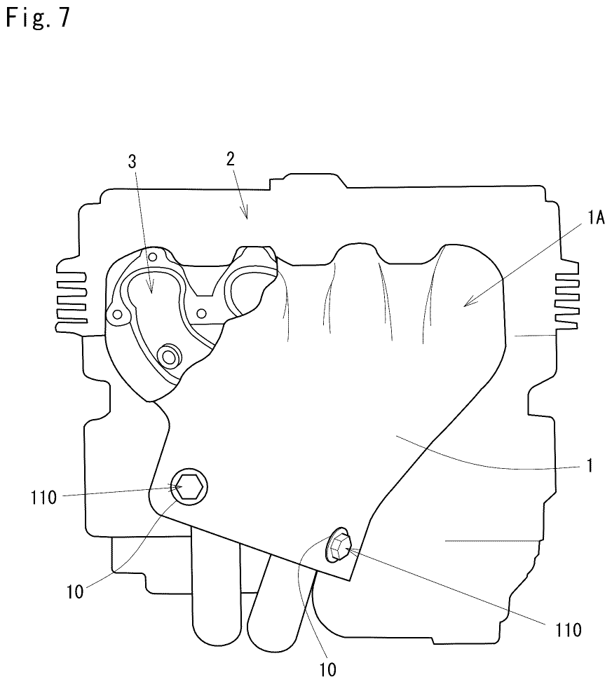

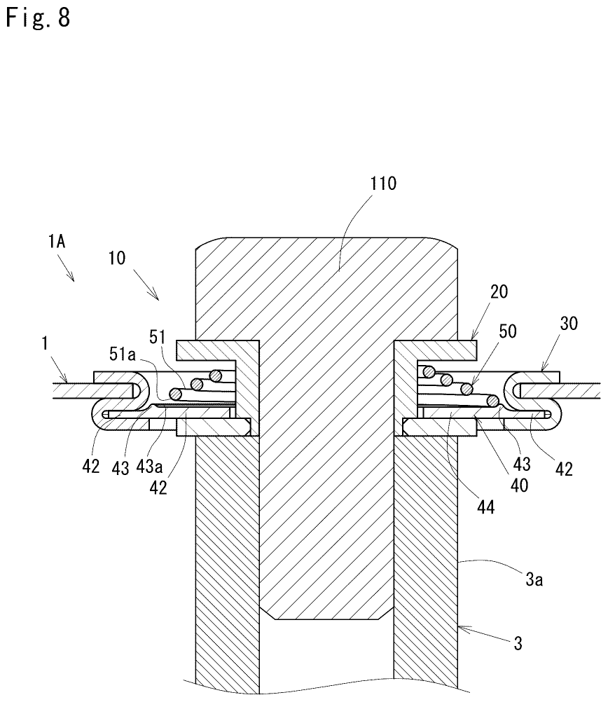

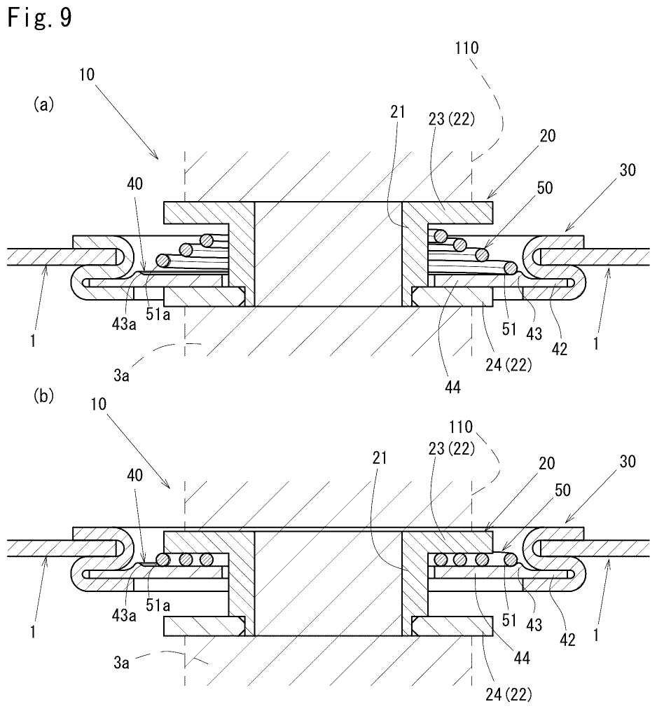

FIG. 6 is an enlarged partial perspective view of the insulator base 100 to be the heat insulator 1 with the shock absorber 10. FIG. 7 is a schematic front view of a shock absorber-attached heat insulator 1A mounted on an engine 2. FIG. 8 is a schematic cross-sectional view of the shock absorber 10 attached. FIG. 9 is a view of the shock absorber 10 attached. In detail, FIG. 9(a) is a schematic vertical cross-sectional view of the shock absorber 10 under no load, and FIG. 9(b) is a schematic vertical cross-sectional view of the shock absorber 10 under a load.

The term upward refers to the top in FIGS. 3 to 9, and the term downward refers to the bottom in these figures.

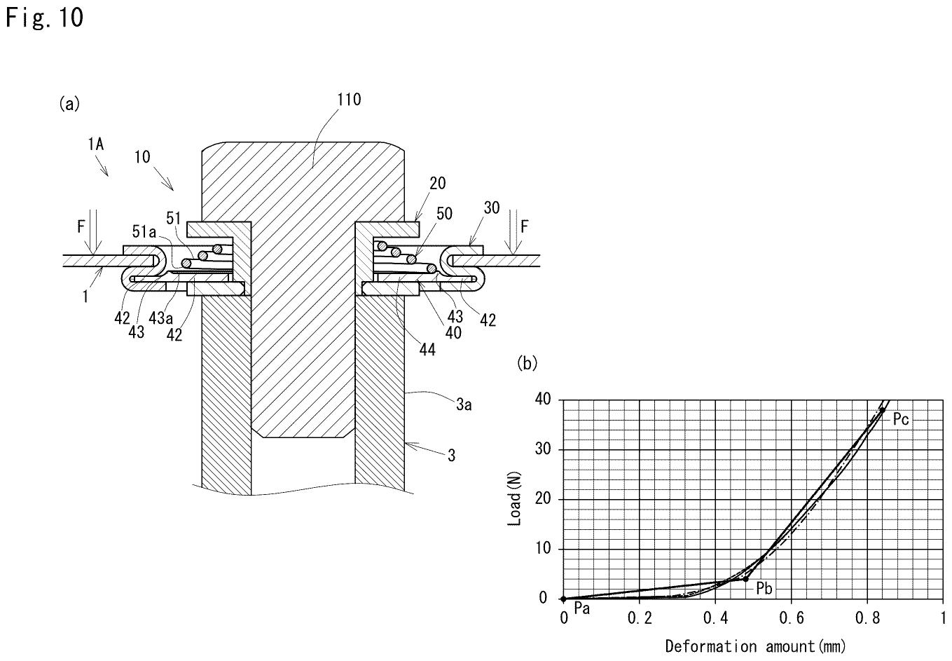

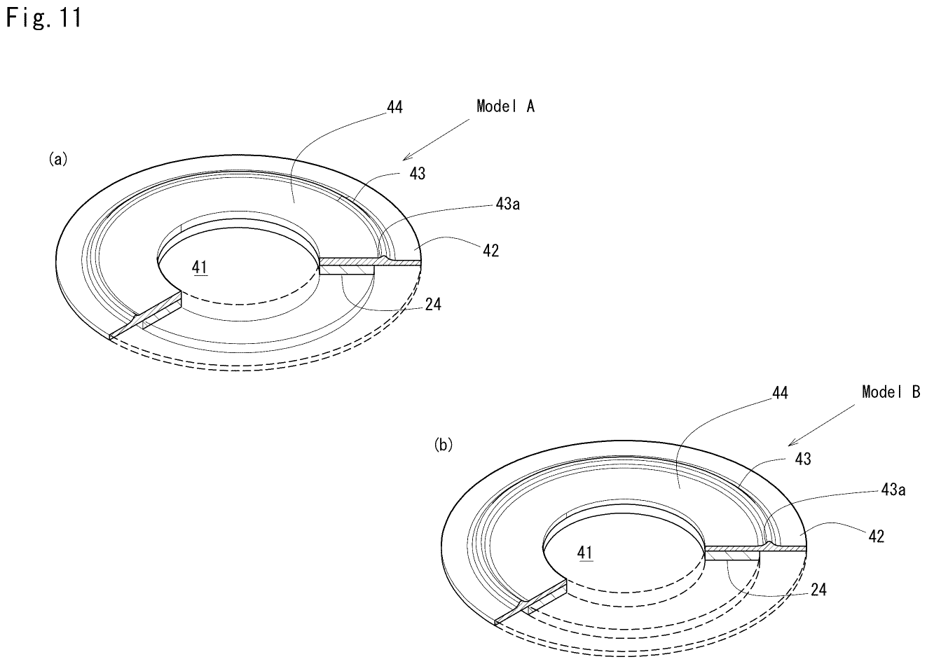

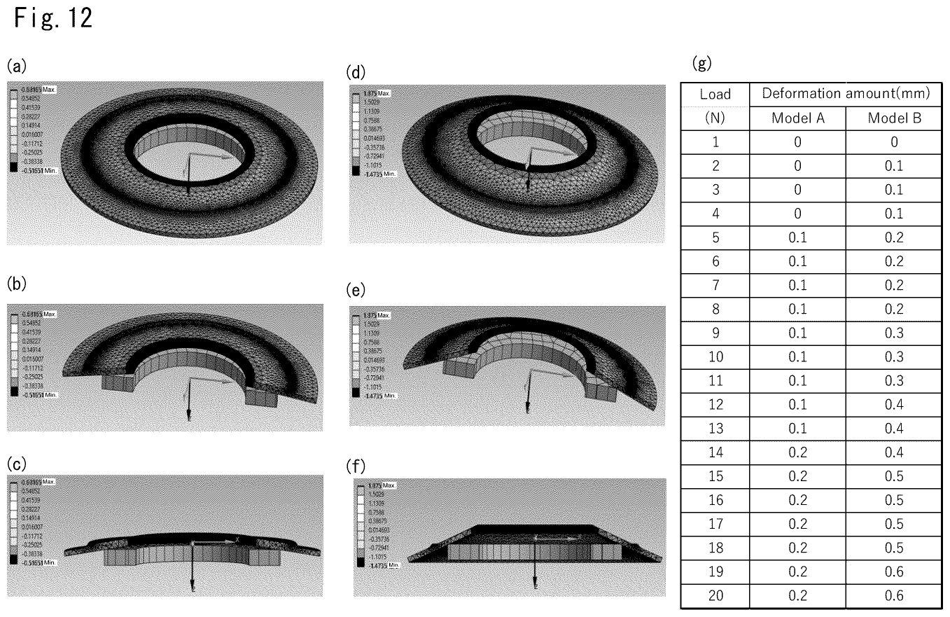

FIG. 10 is a view of a tensile test. FIG. 11 is a view of a damping member model. FIG. 12 is a view of simulation result.

In detail, FIG. 10(a) is a schematic view of the tensile test conducted on the shock absorber 10. FIG. 10(b) shows the graph of the tensile test results.

FIG. 11(a) is a schematic perspective view of an analytical model A. FIG. 11(b) is a schematic perspective view of an analytical model B.

FIG. 12(a), FIG. 12(b) and FIG. 12(c) are views of a simulation result of the analytical model A. FIG. 12(d), FIG. 12(e) and FIG. 12(f) are views of a simulation result of the analytical model B. FIG. 12(g) shows a numerical data of the simulation result of the analytical model A and the analytical model B.

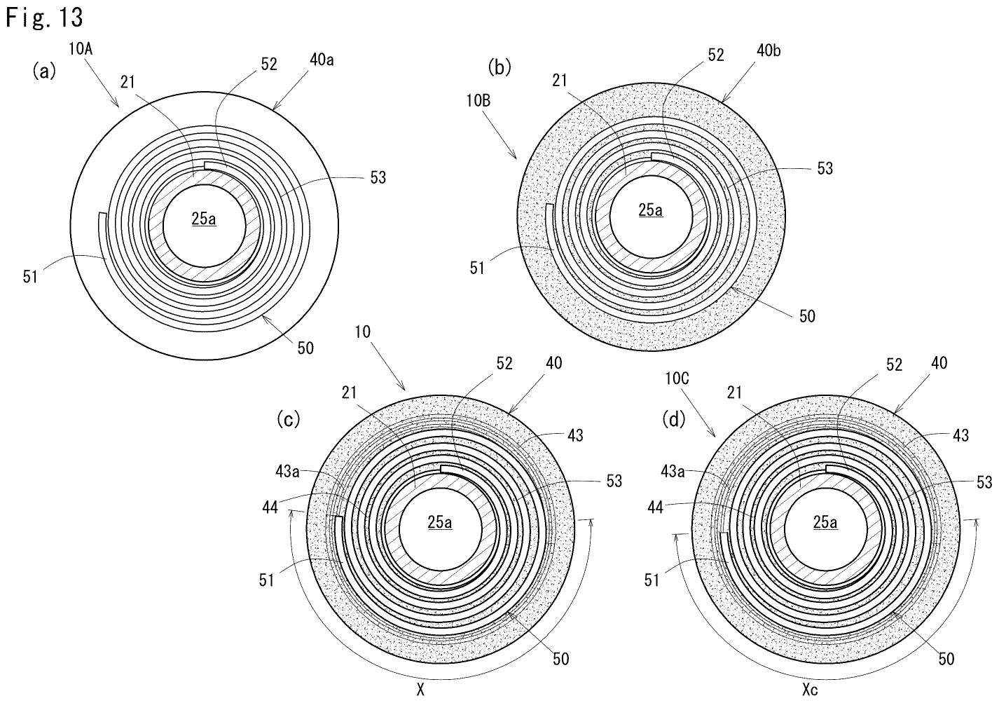

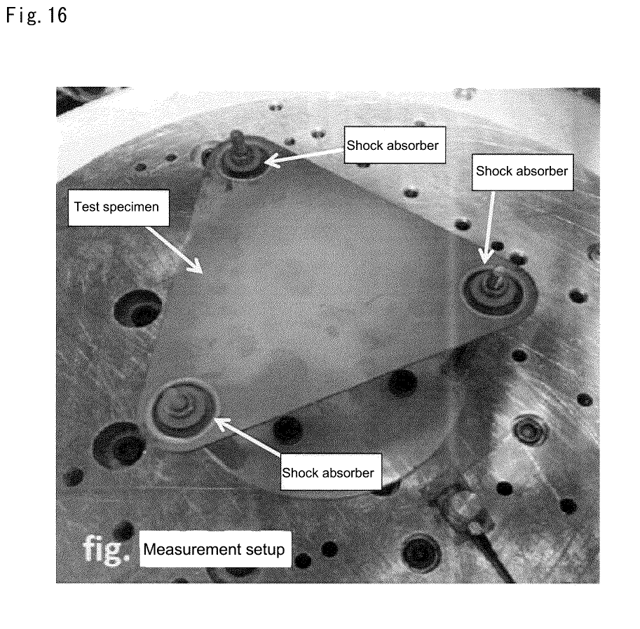

FIGS. 13 to 15 are views of shock absorbers used in damping evaluation tests. FIG. 16 is a photograph showing the damping evaluation test conditions.

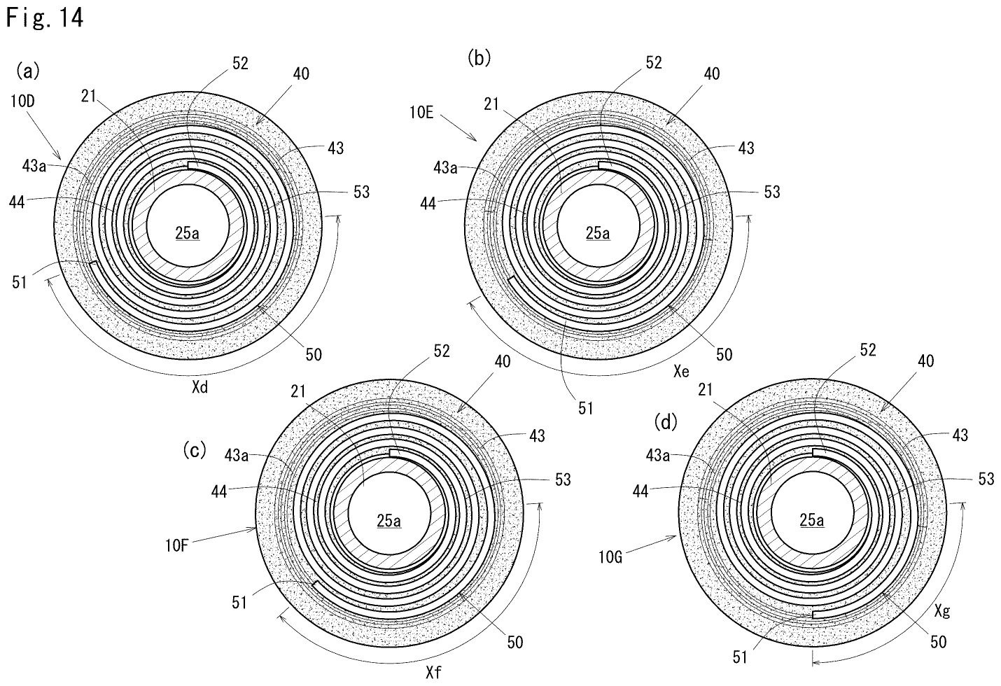

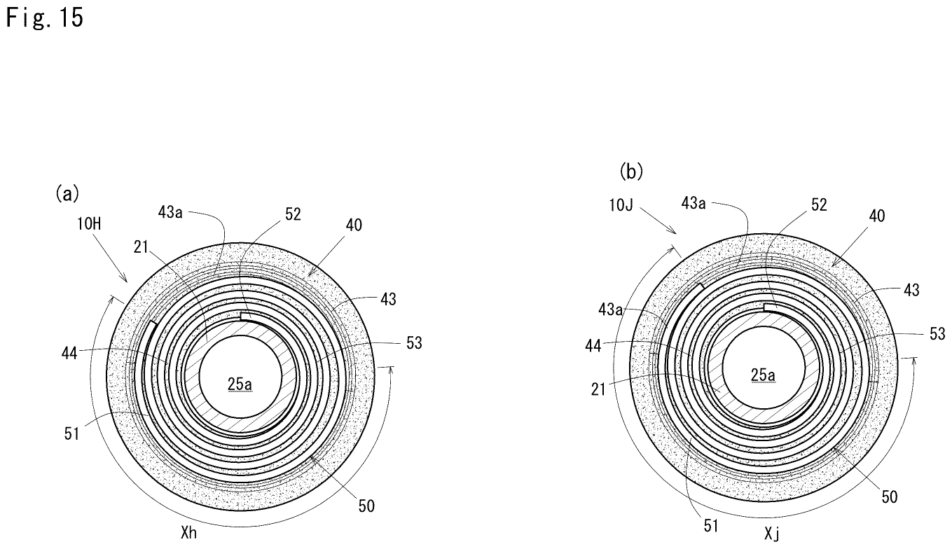

In detail, FIG. 13(a) is a horizontal cross-sectional view of a shock absorber 10A, FIG. 13(b) is a horizontal cross-sectional view of a shock absorber 10B, FIG. 13(c) is a horizontal cross-sectional view of the shock absorber 10, and FIG. 13(d) is a horizontal cross-sectional view of a shock absorber 10C. FIG. 14(a) is a horizontal cross-sectional view of a shock absorber 10D, FIG. 14(b) is a horizontal cross-sectional view of a shock absorber 10E, FIG. 14(c) is a horizontal cross-sectional view of a shock absorber 10F, and FIG. 14(d) is a horizontal cross-sectional view of a shock absorber 10G. FIG. 15(a) is a horizontal cross-sectional view of a shock absorber 10H, and FIG. 15(b) is a horizontal cross-sectional view of a shock absorber 10J.

As described later, the shock absorber 10 is a mounting fixture for mounting the heat insulator 1 onto the engine 2. As shown in FIGS. 1 and 2, the shock absorber 10 includes the substantially annular collar 20 located at the center in a plan view, the radially outward grommet 30, and the compression mesh 40 and the spiral spring 50 located between the collar 20 and the grommet 30.

The collar 20 is substantially tubular and has a smaller height than its diameter. The collar 20 is formed from an iron-based material, such as steel plate cold commercial (SPCC). The collar 20 includes a tubular collar shaft 21 extending vertically to receive a fastening bolt 110 (refer to FIG. 8) and annular flanges 22 (23, 24) protruding radially outward from the upper and lower ends of the collar shaft 21. The collar shaft 21 and the flanges 22 are integral with each other.

More specifically, as shown in FIG. 3, the collar 20 includes a collar part 25 including the collar shaft 21 and the upper flange 23 that are integral with each other, and the toroidal lower flange 24 having a fitting hole 24a at the center in a plan view for receiving the lower end of the collar shaft 21. The upper flange 23 and the lower flange 24 are disks with the same diameter. The collar part 25 has a bolt hole 25a extending vertically from the upper flange 23 to the lower end of the collar shaft 21.

The collar shaft 21 in the collar part 25 integrally including the collar shaft 21 and the upper flange 23 has the lower end fitted in the fitting hole 24a at the center of the lower flange 24 in a plan view. The collar shaft 21 has the lower end swaged to integrate the collar part 25 and the lower flange 24 together, forming the collar 20.

In the present embodiment, the collar shaft 21 is tubular and has a diameter of 10 mm. The distance between the flanges 22 on the upper and lower ends, or more specifically, the vertical length from the bottom surface of the upper flange 23 to the upper surface of the lower flange 24 is, but not limited to, about 4 mm, which is about one-third of the diameter of the collar shaft 21.

The grommet 30 is a ring member that is annular in a plan view, and formed from a metal plate processed into a substantially S-shape in a half cross section. The grommet 30 includes a first fixing section 31 for holding the heat insulator 1 radially outward, a second fixing section 32 for holding a radially outer peripheral portion 42 of the compression mesh 40 radially inward, and a connecting section 33 radially connecting the lower end of the first fixing section 31 and the upper end of the second fixing section 32. The first fixing section 31, the connecting section 33, and the second fixing section 32 are arranged in the stated order from above and integral with one another.

The first fixing section 31 is formed by folding, radially outward, an upper portion of a metal plate corresponding to a radially inward portion from the connecting section 33. The first fixing section 31 has a substantially lateral U shape open radially outward in half cross section. The first fixing section 31 fixes the heat insulator 1 together with the connecting section 33 by swaging.

The second fixing section 32 is formed by folding, radially inward, a lower portion of a metal plate corresponding to a radially outward portion from the connecting section 33. The second fixing section 32 has a substantially lateral U shape open radially inward in half cross section. The second fixing section 32 fixes the radially outer peripheral portion 42 of the compression mesh 40 (described later) together with the connecting section 33 by swaging.

The grommet 30 with the above ring structure has an inner diameter larger than the outer diameter of the collar 20 (or the outer diameters of the flanges 22) and a height substantially the same as the distance between the flanges 22 on the collar 20.

The compression mesh 40, which mainly provides shock absorbing performance in the shock absorber 10, is formed from wires knitted and compressed together into a ring with a center hole 41 in a plan view for receiving the collar shaft 21. As shown in FIG. 4, a radially outward part of the compression mesh 40 is the radially outer peripheral portion 42 that is fixed to the second fixing section 32 of the grommet 30 by swaging, and a radially inward part of the compression mesh 40 is a radially inner peripheral portion 44 that is thicker than the radially outer peripheral portion 42. The compression mesh 40 has, on its upper surface, a restriction ridge 43 between the radially outer peripheral portion 42 and the radially inner peripheral portion 44. The compression mesh 40 with the radially outer peripheral portion 42 fixed to the second fixing section 32 is vertically bendable and compressible.

More specifically, the compression mesh 40 is formed from stainless steel (SUS316) wires knitted together, with stockinette stitch, into a substantially tubular shape, and compressed in the thickness direction. The wires have circular cross sections with a diameter of 0.2 mm. The radially outer peripheral portion 42 is compressed into an annular shape with a thickness of 1.0 mm, which is less than the distance between the upper flange 23 and the lower flange 24. And the radially inner peripheral portion 44 is compressed into an annular shape with a thickness of 2.0 mm, which is twice of the thickness of the radially outer peripheral portion 42. The radially outer peripheral portion 42 is thus elastically deformable, and has a spring constant of about 8.3 N/mm. The radially inner peripheral portion 44 is thus elastically deformable, and has a spring constant of about 94.4 N/mm. The compression mesh 40 is thus elastically deformable, or bendable and compressible, and has a spring constant of about 20 N/mm.

Thickness of the radially inner peripheral portion 44 is twice of the one of the radially outer peripheral portion 42, and a bottom surface of the radially inner peripheral portion 44 and the radially outer peripheral portion 42 are flat. So, an upper surface of the radially inner peripheral portion 44 protrudes more upwards than the one of the radially outer peripheral portion 42.

The center hole 41 has an inner diameter slightly larger than the diameter of the collar shaft 21 of the collar 20. The center hole 41 is circular in a plan view and extends through the compression mesh 40 vertically.

In the present embodiment, the compression mesh 40 radially connecting the collar and the grommet 30 has an outer diameter of 28 mm and an inner diameter of 12 mm. However, the diameter of the wires forming the compression mesh 40, the dimensions of the compression mesh 40, and the spring constant are not limited and may be set as appropriate. The compression mesh 40 with the performance described above may undergo no compression process.

The compression mesh 40 has, on its upper surface, a restriction ridge 43 extending along the circumference of a lower large-diameter portion 51 of the spiral spring 50 (described later). The restriction ridge 43 is circular in a plan view and protrudes upward.

The restriction ridge 43 which located between the radially outer peripheral portion 42 and the radially inner peripheral portion 44 is formed to straddle the upper surface of the radially outer peripheral portion 42 and the radially inner peripheral portion 44. And the restriction ridge 43 protrudes more upwards than the upper surface of the radially inner peripheral portion 44 formed with twice the thickness of the radially outer peripheral portion 42.

As shown in an enlarged view of an area a in FIG. 2, the restriction ridge 43 is formed a smooth curved cross section. The restriction ridge 43 is along an outer circumferential surface of the lower large-diameter portion 51 of the spiral spring 50 (described later) from the upper surface of the radially inner peripheral portion 44. More specifically, a hem part 43a which is located the radially inner circumference of the restriction ridge 43 is formed curved cross section which has approximately the same radius as the cross-sectional radius of the lower large-diameter portion 51. The hem part 43a contacts a lower half outer circumferential portion 51a which is located radially outward and lower of the lower large-diameter portion 51.

And the restriction ridge 43 protrudes upward from the upper surface of the radially inner peripheral portion 44. The height of the restriction ridge 43 is about ⅓ of a cross-sectional diameter of the lower large-diameter portion 51. So, the hem part 43a can contact with the lower half outer circumferential portion 51a, certainly.

As shown in an enlarged view of an area a in FIG. 2, the restriction ridge 43 protrudes upward from the surface of the compression mesh 40 with a smooth curve along the outer circumferential surface of the lower large-diameter portion 51 in a vertical cross section. In some embodiments, the restriction ridge 43 may be a separate member fixed on the surface of the compression mesh 40, or may have non-rounded corners in a vertical cross section.

The spiral spring 50 is formed from a wire having a circular cross section wound radially and upward to be spiral in a plan view and substantially truncated in a side view. The spiral spring 50 has diameters larger in lower portions than in upper portions. The lowermost portion having a larger diameter is referred to as the lower large-diameter portion 51, whereas the uppermost portion having a smaller diameter is referred to as an upper small-diameter portion 52.

More specifically, the spiral spring 50 has the lower large-diameter portion 51 corresponding substantially to one turn along the circumference at the lower end, the upper small-diameter portion 52 corresponding substantially to one turn along the circumference at the upper end, and an effective spring portion 53 between the lower large-diameter portion 51 and the upper small-diameter portion 52.

The lower large-diameter portion 51 and the upper small-diameter portion 52 are wound on a plane substantially perpendicular to the axial direction (vertical direction), or more specifically, on a horizontal plane. As described above, the lower large-diameter portion 51 extends along the inner circumference of the restriction ridge 43 on the upper surface of the compression mesh 40. The upper small-diameter portion 52 is less loosely fitted on the collar shaft 21 of the collar 20.

The equilibrium length of the spiral spring 50, or more specifically, the height of the spiral spring 50 under no load, that is, the vertical distance between the lower large-diameter portion 51 and the upper small-diameter portion 52, is greater than the distance between the flanges 22 on the collar 20 described above, or more specifically, the vertical height between the bottom surface of the upper flange 23 and the upper surface of the lower flange 24.

In the present embodiment, the spiral spring 50 with the above structure includes the lower large-diameter portion 51 with a diameter of 26 mm and the upper small-diameter portion 52 with a diameter of 10 mm. The effective spring portion 53 between the lower large-diameter portion 51 and the upper small-diameter portion 52 includes two turns. The spiral spring 50 is truncated in a side view and has a height (equilibrium length) of 6.6 mm under no load.

The diameters of the lower large-diameter portion 51 and the upper small-diameter portion 52, the number of turns included in the effective spring portion 53, and the height of the spiral spring 50 are not limited to the values described above, and may be determined to provide appropriate dimensions and an intended elastic force. The spring constant of the spiral spring 50 may be set to, but not limited to, about 0.5 N/mm, which is 1/40 to ½ of the spring constant of the compression mesh 40 (about 20 N/mm).

A method for assembling the shock absorber 10 including the collar 20, the grommet 30, the compression mesh 40, and the spiral spring 50 described above will now be described.

The radially outer peripheral portion 42 of the compression mesh 40 is fixed to the second fixing section 32 of the grommet 30 with the connecting section 33 by swaging to fix the grommet 30 and the compression mesh 40 together.

As shown in FIG. 3, the spiral spring 50 is vertically overlaid on the compression mesh 40. From above the spiral spring 50 vertically overlaid on the compression mesh 40, the collar shaft 21 of the collar part 25 is placed through the opening defined by upper small-diameter portion 52 of the spiral spring 50 and through the center hole 41 in the compression mesh 40. The lower end of the collar shaft 21 is swaged in the fitting hole 24a in the lower flange 24 on the bottom surface of the compression mesh 40 to be integral with the lower flange 24. The compression mesh 40 may be fixed to the grommet 30 before or after the collar 20 is fixed to the compression mesh 40 and the spiral spring 50 vertically overlaid on each other.

In the structure including the collar 20 and the compression mesh 40 and the spiral spring 50 vertically overlaid on each other, the spiral spring 50 is vertically compressed with the upper small-diameter portion 52 restricted by the upper flange 23 at the top and tightly fitted on the collar shaft 21. In the present embodiment, the spiral spring 50 with a height of 6.6 mm under no load (equilibrium length) is attached in a manner compressed to have a vertical height of about 3 mm. The vertical height may be a different length.

The lower large-diameter portion 51 extends along the radially inner circumference of the restriction ridge 43 on the upper surface of the compression mesh 40, which is fixed to the grommet 30 with the radially outer peripheral portion 42 swaged to the second fixing section 32. The lower large-diameter portion 51 urges the compression mesh 40 downward. More specifically, as shown in FIG. 5, the lower large-diameter portion 51 extends along 55% of the radially inner circumference of the restriction ridge 43. The area of the lower large-diameter portion 51 circumferentially in contact with the restriction ridge 43 is referred to as a contact area X.

The shock absorber 10 assembled in the above manner is attached at a predetermined position on the heat insulator 1 to provide a shock absorber-attached heat insulator 1A.

More specifically, the shock absorber 10 is placed in an installation hole 101 (refer to FIG. 3) at a predetermined position on the heat insulator 1 to be the shock absorber-attached heat insulator 1A. The circumferential edge of the installation hole 101 and the first fixing section 31 are swaged together to fix the shock absorber 10 to the insulator base 100.

In FIG. 6, the insulator base 100 is flat. In some embodiments, the insulator base 100 may be corrugated. Although the shock absorber 10 is fixed on the flat insulator base 100 in FIG. 6, the insulator base 100 having the installation hole 101 at a predetermined position is first processed into the three-dimensional heat insulator 1, and then the installation hole 101, which is used to mount the heat insulator 1 onto the engine 2, receives the shock absorber 10 to form the shock absorber-attached heat insulator 1A.

As shown in FIG. 7, the shock absorber-attached heat insulator 1A with the above structure is mounted on the engine 2 for a vehicle, such as an automobile, to cover the exhaust manifold 3 that discharges a combustion exhaust gas.

More specifically, as shown in FIG. 8, the exhaust manifold 3 includes a boss 3a at a predetermined position determined in accordance with the vibration characteristics of the engine 2. The shock absorber 10 attached in the shock absorber-attached heat insulator 1A is placed on the boss 3a. The fastening bolt 110 is placed through the bolt hole 25a defined in the collar shaft 21 included in the shock absorber 10 and screwed onto the boss 3a in the exhaust manifold 3 for fastening.

In the shock absorber-attached heat insulator 1A fixed to the exhaust manifold 3 as described above, the vibration of the exhaust manifold 3 from driving the engine 2 is input to the collar 20 through the boss 3a. The compression mesh 40 and the spiral spring 50 located between the collar 20 and the grommet 30 damp vibration input through the collar 20, thus reducing vibration input to the heat insulator 1 through the grommet 30. In other words, the shock absorber 10 can damp vibration input from the exhaust manifold 3.

As described above, the shock absorber 10 for connecting the exhaust manifold 3 as a vibration source and the heat insulator 1 for covering the exhaust manifold 3 to absorb vibration from the exhaust manifold 3 to the heat insulator 1 includes the collar 20 including the substantially tubular collar shaft 21 to be fastened to the exhaust manifold 3 with the fastening bolt 110, and the annular flanges 22 protruding radially outward from the two axial ends of the collar shaft 21, the annular grommet 30 fixable to the heat insulator 1, the annular compression mesh 40 located between the collar 20 and the grommet 30 with the radially outer peripheral portion of the compression mesh 40 fixed to the grommet 30 and including a shock absorbing material, and the spiral spring 50 located between the upper flange 23 on the collar and the compression mesh 40, and overlaid on the compression mesh 40. The compression mesh 40 includes the radially inner peripheral portion 44 which located a radially inward part of the shock absorbing member and has a center hole 41 loosely receiving the collar shaft 21 at least in the radial direction. The spiral spring 50 has a spring constant equal to or smaller than the spring constant of the compression mesh 40 and is substantially truncated in a side view which has the larger diameter in the portion nearer the compression mesh 40 than in a portion nearer the at least one of the flanges, is spiral in a plan view. The radially inner peripheral portion 44 of the compression mesh 40 is thicker than the radially outer peripheral portion 42 fixed to the fixing member. The compression mesh 40 includes the restriction ridge 43 along and in contact with the lower large-diameter portion 51 radially outward in the spiral spring 50 spiral in a plan view. The restriction ridge 43 restricts radial movement of the spiral spring 50 relative to the compression mesh 40. The restriction ridge 43 locates between the radially inner peripheral portion 44 and the radially outer peripheral portion 42, and is adjacent to the spiral spring 50 on the compression mesh 40. The restriction ridge 43 includes the hem part 43a protruding to outwardly more than the radially inner peripheral portion 44, and extends along and is in contact with the radially outer portion that is radially outward in the spiral spring 50. The spiral spring 50 has the lower large-diameter portion 51 in contact with 55% of the circumference of the restriction ridge 43, which falls within the range of 40% to 55%. The shock absorber 10 thus has higher vibration damping performance while reducing contact noise generated as the compression mesh 40 hits the collar 20.

In detail, the annular compression mesh 40 located between the collar 20 and the grommet 30 with the radially outer peripheral portion 42 fixed to the grommet 30 and including a shock absorbing material is axially bendable and thus deforms elastically. This reduces the vibration from the exhaust manifold 3 transmitted to the grommet 30 through the collar 20, thus reducing the vibration from the exhaust manifold 3 propagating to the heat insulator 1, or in other words, absorbing such vibration.

The center hole 41 in the compression mesh 40 loosely receives the collar shaft 21 at least in the radial direction. The compression mesh 40 thus moves at least radially relative to the collar 20 that vibrates as the exhaust manifold 3 vibrates. This structure can damp vibration, and reduces vibration propagating to the compression mesh 40.

The spiral spring 50 located between the upper flange 23 on the collar 20 and the compression mesh 40 and overlaid on the compression mesh 40 has a lower spring constant than the compression mesh 40. The elastically deformable spiral spring 50 thus absorbs at least radial movement of the compression mesh 40 relative to the vibrating collar 20 as described above. This reduces contact noise generated as the compression mesh 40 moves relative to the collar 20 under vibration propagating to the collar 20, without lowering the shock absorbing performance of the compression mesh 40.

The compression mesh 40 includes the restriction ridge 43 in contact with the lower large-diameter portion 51 radially outward in the spiral spring 50 spiral in a plan view. The contact area X of the lower large-diameter portion 51 with the restriction ridge 43 is in the range of 40% to 55%. In this structure, friction between the restriction ridge 43 and the lower large-diameter portion 51 further damps vibration input to the shock absorber 10, in addition to damping with the spiral spring 50.

A structure with the contact area X of the lower large-diameter portion 51 with the restriction ridge 43 less than 40% cannot have such friction between the restriction ridge 43 and the lower large-diameter portion 51 that allows damping described above, and may have substantially the same damping as obtained with the spiral spring 50 fixed to the compression mesh 40, or in other words, damping with the spiral spring 50 alone.

As described above, the structure with the circumferential contact area X of the lower large-diameter portion 51 with the restriction ridge 43 in a range of 40% to 55% provides further damping with friction between the restriction ridge 43 and the lower large-diameter portion 51, in addition to damping with the spiral spring 50. The shock absorber 10 can thus further damp input vibration, providing high vibration damping performance.

The restriction ridge 43 on the compression mesh 40 adjacent to the spiral spring 50 has an outwardly-curved cross section. The restriction ridge 43 can be formed easily to generate friction with the lower large-diameter portion 51 of the spiral spring 50, thus damping the vibration further.

In detail, the restriction ridge 43 having an outwardly-curved cross section and located on the compression mesh 40 adjacent to the spiral spring 50 reliably prevents radial movement of the spiral spring 50 relative to the compression mesh 40 and also reliably comes in contact with the lower large-diameter portion 51 to generate intended friction. The shock absorber 10 thus has increased damping, or more specifically, high vibration damping performance.

The compression mesh 40 includes metal wires knitted together. This increases friction between the restriction ridge 43 and the lower large-diameter portion 51 to further increase damping, thus providing the shock absorber 10 having higher vibration damping performance.

The spiral spring 50 is substantially truncated in a side view and has a larger diameter in a portion nearer the compression mesh 40 than in a portion nearer the flange 22. The spiral spring 50 thus axially compresses by a greater degree than a coil spring having the same diameter from the upper to lower ends. This structure provides space for movement of the compression mesh 40 relative to the collar 20 for deforming elastically and absorbing vibration, and reliably prevents the compression mesh 40 from lowering the absorbing performance.

This structure also prevents wire portions included in the spiral spring 50 from coming in contact with each other when the spiral spring 50, which is spiral in a plan view and substantially truncated in a side view, compresses under a load.

The spiral spring 50 is substantially truncated in a side view and has a height greater than the distance between the compression mesh 40 in contact with the lower flange 24 and the upper flange 23. The spiral spring 50 is attached in a manner compressed against the axial urging force, or in other words, the spiral spring 50 is attached in a prestressed manner. The spiral spring 50 thus reliably reduces contact noise generated as the compression mesh 40 hits the collar 20, and increases friction between the spiral spring 50 and the restriction ridge 43 in contact with each other, thus further improving damping of the shock absorber 10.

The spiral spring 50 has a spring constant of 0.5 N/mm, which is 1/40 to ½ of the spring constant of the compression mesh 40 (about 20 N/mm). This allows damping with friction between the restriction ridge 43 and the lower large-diameter portion 51.

In detail, when the spiral spring 50 has a spring constant smaller than 1/40 of the spring constant of the compression mesh 40, the compression mesh 40 mainly performs damping. This reduces friction between the restriction ridge 43 and the lower large-diameter portion 51, without providing sufficient damping with friction between the restriction ridge 43 and the lower large-diameter portion 51. When the spiral spring 50 has a spring constant larger than ½ of the spring constant of the compression mesh 40, the compression mesh 40 is mostly bent, without providing sufficient damping with the restriction ridge 43 and the lower large-diameter portion 51. When the spiral spring 50 has a spring constant in a range of 1/40 to ½ (about 0.5 N/mm) of the spring constant of the compression mesh 40 (about 20 N/mm), the friction between the restriction ridge 43 and the lower large-diameter portion 51 provides sufficient damping.

The shock absorber 10 is attached to the heat insulator 1 for covering the exhaust manifold 3 to provide the shock absorber-attached heat insulator 1A. The shock absorber 10 absorbs vibration from the exhaust manifold 3 and prevents the heat insulator 1 from being a vibration source by resonating with the exhaust manifold 3. The shock absorber-attached heat insulator 1A reduces contact noise between the collar 20 and the compression mesh 40, and improves damping to provide high vibration damping performance.

In the compression mesh 40, the thickness of the radially inner peripheral portion 44 which located the radially inner circumference of the compression mesh 40 is twice of the one of the radially outer peripheral portion 42 which located the radially outward part of the compression mesh 40, and a bottom surface of the radially inner peripheral portion 44 and the radially outer peripheral portion 42 are flat. The restriction ridge 43 protrudes more upwards than the upper surface of the radially inner peripheral portion 44.

And more, the hem part 43a which located the radially inner circumference of the restriction ridge 43 is formed a curved cross section which has approximately the same radius as the cross-sectional radius of the lower large-diameter portion 51. The height of the restriction ridge 43 which protrudes more upwards than the upper surface of the radially inner peripheral portion 44 is about ⅓ of the cross-sectional diameter of the lower large-diameter portion 51.

Thus, the hem part 43a reliably contacts the lower half outer circumferential portion 51a which is located radially outward and lower of the lower large-diameter portion 51. Therefore, the shock absorber 10 provides more further damping with friction between the restriction ridge 43 and the lower large-diameter portion 51 than the lower large-diameter portion 51 in contact with the movement restriction ridge which has a channel cross section protruding more upwards than the radially inner peripheral portion.

The radially inner peripheral portion 44 is twice thickness of the one of the radially outer peripheral portion 42. And the compression mesh 40 has the restriction ridge 43 between the radially outer peripheral portion 42 and the radially inner peripheral portion 44. The hem part 43a of the restriction ridge 43 contacts certainly the lower half outer circumferential portion 51a which is located radially outward and lower of the lower large-diameter portion 51.

Such the hem part 43a can suppress the amount of deformation by input vibration, in compared to the flat shape compression mesh which has the channel cross section protruding upward between radially outward and the radially inner circumference.

By the structure, the compression mesh 40 can be to keep the contact of the hem part 43a and the lower half outer circumferential portion 51a, even if the vibration is input to the shock absorber 10. Thus, the shock absorber 10 provides more further damping with friction between the restriction ridge 43 and the lower large-diameter portion 51, in compared to the flat shape compression mesh.

Next, the simulation results of the deformation amount at the restriction ridge under vibration applied with a damping member model (an analytical model A and an analytical model B) are then described with FIGS. 10 to 12. The damping member model is a substantially tubular shape, and has the restriction ridge between a radially inward part and a radially outward part.

The analytical model A corresponds to the compression mesh 40. More specifically, the analytical model A is formed a ring with a center hole in a plan view, and has the radially inward part which is twice thickness of the radially outward part. In addition, the analytical model A has the restriction ridge between a radially inward part and a radially outward part. The restriction ridge is formed the same shape as the restriction ridge 43.

The analytical model B is formed a ring with a center hole in a plan view. More specifically, the analytical model B has the radially inward part which is same thickness of the radially outward part, and has the restriction ridge between a radially inward part and a radially outward part. The restriction ridge of the analytical model B is the same as shape the one of the analytical model A.

To be consistent with the shock absorber 10 and the simulation result of the analytical model A, a tensile test is performed on the shock absorber 10, and the deformation of the shock absorber 10 in the thickness direction with respect to the load is analyzed. The result of the tensile test is set as the analysis conditions for the simulations of the analytical model A and the analytical model B.

More specifically, as shown in FIG. 10(a), a measurement of the deformations in the thickness direction against the load was performed, to applied the load F to the shock absorber 10. The result of the measurement is shown in FIG. 10(b). To enter into the simulation conditions, a relation of the deformations in the thickness direction against the load which analyzed by the tensile test was converted to a relation of strain to stress.

More specifically, as shown in FIG. 10(b), it was calculated an approximate straight line through points Pa and Pb from the measurement of the deformations against the load. Similarly, it was calculated an approximate straight line through points Pb and Pc from the measurement of the deformations against the load.

And a relationship of the strain and stress is converted from the approximate straight line through points Pa to Pb and Pb to Pc. And then, the relationship of the strain and stress is entered into the simulation conditions.

Described above, the shock absorber 10 includes the substantially annular collar 20, the radially outward grommet 30, the compression mesh 40 and the spiral spring 50. When the vibration is propagated to the shock absorber 10, an upward load applies on the compression mesh 40. In this case, the radially inner peripheral portion 44 is pressed against the lower flange 24. Therefore, to simulate the damping member model (the analytical model A and the analytical model B), the location corresponding to the lower flange 24 was set as fixed points.

When the radially inner circumferential portion 44 is pressed against the lower flange 24 due to vibration propagated to the shock absorber 10, a downward load relatively applies the radially outer circumferential portion 42 swaged to the second fixing section 32 of the grommet 30. Therefore, to simulate the damping member model (the analytical model A and the analytical model B), the location corresponding to the radially outer circumferential portion 42 was set as input points where downward force is applied.

The damping member models (the analytical model A and the analytical model B) are divided into simple geometric elements and set up analysis meshes to simulate the damping member models. As the analysis condition, the relationship of the strain and stress was inputted to the damping member models setting up the analysis meshes. Base on the damping member models set up in this way, the simulations are performed to analyze the behavior of the analysis meshes corresponding to the hem part 43a of the restriction ridge 43 (refer to FIG. 11).

The deformation amount of the analysis meshes corresponding to the hem part 43a is 0.681 mm, when inputted the downward force is 20 N to the analytical model A. In the tensile test described above, when the load of 20N applied to the shock absorber 10, the deformation amount of the shock absorber 10 is 0.68 mm. So, it is confirmed that the analysis results of the analytical model A are valid.

As shown in FIG. 7 and FIG. 8, the load of 20N applied the analytical model A to confirm the validity of the analysis results in the tensile test is approximately equal to vibration force that input to the shock absorber 10 by the vibration of the exhaust manifold 3 from driving the engine 2. By the way, the shock absorber 10 is mounted to the engine 2 through the boss 3a. Thus, the load of 20N was adopted as the vibration force to verify validity of the analytical model A.
the relationship of the strain and stress described above was entered into the damping member models setting up the analysis meshes as the analysis condition of the simulation. FIG. 12 is shown the simulation result of the damping member model.

FIG. 12(a) is a schematic perspective view of the simulation result of the analytical model A. FIG. 12(b) is a schematic half section perspective view of the simulation result of the analytical model A. FIG. 12(c) is a schematic vertical cross-sectional view of the simulation result of the analytical model A. As same as, FIG. 12(d) is a schematic perspective view of the simulation result of the analytical model B. FIG. 12(e) is a schematic half section perspective view of the simulation result of the analytical model B. FIG. 12(f) is a schematic vertical cross-sectional view of the simulation result of the analytical model B. And FIG. 12(g) is a numeric data of simulation result of the analytical model A and the analytical model B.

More specifically, FIG. 12(g) is the deformation amount of the analysis meshes corresponding to the hem part 43a of the restriction ridge 43 in a vertical direction. In the shock absorber 10, the hem part 43a contacts the lower half outer circumferential portion 51a which is located radially outward and lower of the lower large-diameter portion 51 of the spiral spring 50.

In the simulation of the analytical model A, as shown in FIG. 12(g), when the downward force applied to the input point of the analytical model A is up to 4 N, the analysis meshes corresponding to the hem part 43a have almost no deformation in the vertical direction. When the downward force of 5N applied to the input point of the analytical model A, the deformation amount of the analysis meshes corresponding to the hem part 43a is 0.1 mm in the vertical direction. And, when the downward force applied to the input point of the analytical model A increases to 20 N, the deformation amount of the analysis meshes only increases slightly.

On the contrary, when the downward force of 2N applied to the input point of the analytical model B, the deformation amount of the analysis meshes corresponding to the hem part 43a is 0.1 mm in the vertical direction. And when the downward force of 5N applied to the input point of the analytical model B, the deformation amount is 0.2 mm in the vertical direction. When the downward force applied to the input point of the analytical model B increases to 20 N, the deformation amount of the analysis meshes keeps increasing.

In the shock absorber with the damping member corresponding to the analytical model B instead of the compression mesh 40, the lower half outer circumferential portion 51a contacts with parts corresponding to the hem part 43a of the restriction ridge 43 in the damping member corresponding to the analytical model B under no load. The lower half outer circumferential portion 51a is located radially outward and lower of the lower large-diameter portion 51 of the spiral spring 50. Described above, the deformation amount of the analytical model B is large, in the range of the downward force which corresponds to external forces applied by the engine 2 vibrations. Therefore, the contact between the lower half outer circumferential portion 51a and parts corresponding to the hem part 43a may be broken. The shock absorber with the damping member corresponding to the analytical model B cannot provide more further damping with friction between the lower half outer circumferential portion 51a and parts corresponding to the hem part 43a.

On the contrary, in the shock absorber 10 with the compression mesh 40 corresponds to the analytical model A, the lower half outer circumferential portion 51a contacts with the hem part 43a under no load. Described above, the deformation amount of the analysis meshes A is almost unchanged in the range of the downward force which corresponds to external forces applied by the engine 2 vibrations. Therefore, the contact between the lower half outer circumferential portion 51a and the hem part 43a may be keep. The shock absorber 10 with the compression mesh 40 corresponds to the analytical model A provides more further damping with friction between the lower half outer circumferential portion 51a and the hem part 43a.

The compression mesh 40 has the radially inner peripheral portion 44 which is twice thickness of the one of the radially outer peripheral portion 42. In the shock absorber 10 which includes such the compression mesh 40, the deformation amount of the hem part 43a is small in compared to the flat shape compression mesh that the radially outward and the radially inner circumference are equal in thickness. Therefore, the intended friction occurs between the hem part 43a and the lower large-diameter portion 51, and the shock absorber 10 provides more further damping with friction between the lower half outer circumferential portion 51a and the hem part 43a.

Described above, the shock absorber 10 includes the compression mesh 40 confirmed to provide more further damping by the friction occurred between the hem part 43a and the lower large-diameter portion 51. Damping evaluation tests for damping achieved by the spiral spring 50 in the shock absorber 10 with the above advantageous effects will now be described with reference to FIGS. 13 to 16.

Under the test conditions shown in FIG. 16, test specimens each simulating the shock absorber-attached heat insulator 1A including three shock absorbers were used in the damping evaluation tests. The vibration of each specimen was measured under a predetermined vibration. The damping ratios were evaluated and compared.

The shock absorbers used in the tests include a shock absorber 10A (refer to FIG. 13(a)) replacing the compression mesh 40 with an annular iron plate 40a to which the lower large-diameter portion 51 of the spiral spring 50 is fixed, a shock absorber 10B (refer to FIG. 13(b)) including a compression mesh 40b with no restriction ridge 43, the shock absorber 10 described above (refer to FIG. 13(c)) having the circumferential contact area X of the lower large-diameter portion 51 with the restriction ridge 43 of 55% (corresponding to 190°), a shock absorber 10C (refer to FIG. 13(d)) with a contact area Xc of 51.7% (corresponding to 178°), a shock absorber 10D (refer to FIG. 14(a)) with a contact area Xd of 48.4% (corresponding to 167°), a shock absorber 10E (refer to FIG. 14(b)) with a contact area Xe of 44.5% (corresponding to 153°), a shock absorber 10F (refer to FIG. 14(c)) with a contact area Xf of 40.3% (corresponding to 139°), a shock absorber 10G (refer to FIG. 14(d)) with a contact area Xg of 27.5% (corresponding to 95°), a shock absorber 10H (refer to FIG. 15(a)) with a contact area Xh of 62.7% (corresponding to 216°), and a shock absorber 10J (refer to FIG. 15(b)) with a contact area Xj of 68.75% (corresponding to 237°).

Table 1 shows the results.

TABLE 1

| | | | 10 | 10C | 10D | 10E | 10F | 10G | 10H | 10J |
|---|---|---|---|---|---|---|---|---|---|---|
| Shock absorber | 10A | 10B | (55%) | (52%) | (48%) | (45%) | (40%) | (28%) | (63%) | (69%) |
| Damping ratio | 0.18 | 0.27 | 0.35 | 0.3 | 0.32 | 0.32 | 0.22 | 0.18 | 0.19 | 0.19 |

The shock absorber 10A replacing the compression mesh 40 with the iron plate 40a to which the lower large-diameter portion 51 of the spiral spring 50 is fixed can yield the ratio of the radial damping provided by the spiral spring 50. The shock absorber 10B including the compression mesh 40b with no restriction ridge 43 can yield the damping ratio with no radial positional restriction by the restriction ridge 43. More specifically, the shock absorber 10B yields the damping ratio to be obtained when the spiral spring 50 overlaid on the compression mesh 40 absorbs the vertical vibration of the compression mesh 40 alone relative to the collar 20.

The results show that the shock absorbers 10G to 10J have substantially the same damping ratios as the shock absorber 10A under the conditions described above. This reveals that the contact area X of less than 40% provides no damping with friction between the restriction ridge 43 and the lower large-diameter portion 51 in contact with each other and the contact area X of greater than 55% does not provide sufficient damping due to the longer lower large-diameter portion 51 in contact with the restriction ridge 43.

In other words, the tests reveals that the contact area X in a range of 40% to 55%, or more specifically, the lower large-diameter portion 51 in contact with 40% to 55% of the circumference of the restriction ridge 43 provides damping with friction between the restriction ridge 43 and the lower large-diameter portion 51 in contact with each other.

The shock absorbers with the contact area X in a range of 45% to 55%, or more specifically, the shock absorber 10 and the shock absorbers 10C to 10E, provided more effective damping with friction between the restriction ridge 43 and the lower large-diameter portion 51 in contact with each other than the shock absorbers 10A and 10B. This reveals that the circumferential contact area X of the lower large-diameter portion 51 with the restriction ridge 43 may be in a range of 45% to 55% to provide intended damping.

The aspects of present invention correspond to the embodiment in the manner described below: the vibration member in the aspects of the invention corresponds to the exhaust manifold 3,
the covering member to the heat insulator 1,
the shock absorber to the shock absorber 10,
the fastener to the fastening bolt 110,
the collar shaft to the collar shaft 21,
the flange to the flange 22,
the collar to the collar 20,
the fixing member to the grommet 30,
the shock absorbing member to the compression mesh 40,
the spring to the spiral spring 50,
the radially outer portion to the lower large-diameter portion 51,
the movement restrictor and the movement restriction ridge each to the restriction ridge 43,
the radially inner peripheral portion to the radially inner peripheral portion 44,
the radially outer peripheral portion to the radially outer peripheral portion 42, and
the metal cover to the shock absorber-attached heat insulator 1A.

However, the aspects of the invention may be implemented in many embodiments other than the embodiments described above.

In the above embodiment, the lower large-diameter portion 51 is in contact with the restriction ridge 43. In some embodiments, the lower large-diameter portion 51 may be slightly apart from the restriction ridge 43 to immediately come in contact with the restriction ridge 43 under an external force applied radially. The restriction ridge 43 may be replaced with multiple restriction ridges 43 arranged at predetermined intervals to retain the contact area X in the range of 40% to 55% or specifically in the range of 45% to 55%, rather than extending continuously on the circumference.

Although the restriction ridge 43 described above is circular in a plan view, the restriction ridge 43 may be spiral in a plan view with a variable curvature, in accordance with the lower large-diameter portion 51 spiral in a plan view. The contact area X in this structure will be greater than the contact area X of the lower large-diameter portion 51 with the circular restriction ridge 43 in a plan view. This increases damping with friction between the restriction ridge 43 and the lower large-diameter portion 51.

However, the spiral lower large-diameter portion 51 and the spiral restriction ridge 43 in a plan view may be properly aligned to come in contact with each other to increase damping with friction. The spiral spring 50 is to be attached in a properly oriented manner with respect to the compression mesh 40. The compression mesh 40 and the spiral spring 50 attached in an improperly oriented manner may not provide intended damping. To allow any orientation of these components to provide predetermined damping, the circular restriction ridge 43 and the spiral lower large-diameter portion 51 in a plan view may be circumferentially in contact with each other to have the contact area X in a range of 40% to 55%, or specifically 45% to 55%.

In another example, a separate restrictor may be fixed on the surface of the compression mesh 40, rather than the restriction ridge 43 on the compression mesh 40.

In the above embodiment, the spiral spring 50 spiral in a plan view has a spirally increasing height toward the center and is truncated as a whole in a side view, but may have a constant height, i.e., has a plane shape.

In the shock absorber 10 described above, the spiral spring 50 is located on the surface of the compression mesh 40 nearer the upper flange 23. In some embodiments, the spiral spring 50 may be located on the surface of the compression mesh 40 nearer the lower flange 24, or located on each surface of the compression mesh 40 nearer the upper flange 23 or nearer the lower flange 24.

The grommet 30 in the shock absorber 10 has the first fixing section 31, the connecting section 33, and the second fixing section 32 arranged in the stated order from above, and holds the compression mesh 40 and the heat insulator 1 vertically in this order from where the exhaust manifold 3 is located. However, the grommet 30 may have the second fixing section 32, the connecting section 33, and the first fixing section 31 arranged in this order from above, and may hold the heat insulator 1 and the compression mesh 40 vertically in this order from where the exhaust manifold 3 is located.

In this case as well, the spiral spring 50 may be located on the surface of the compression mesh 40 nearer the upper flange 23 or on the surface nearer the lower flange 24, or on each surface nearer the upper flange 23 or nearer the lower flange 24. Also, the spiral spring 50 may have a flat shape in a side view.

### REFERENCE SIGNS LIST

1 heat insulator
1A shock absorber-attached heat insulator
3 exhaust manifold
10 shock absorber
20 collar
21 collar shaft
22 flange
30 grommet
40 compression mesh
42 the radially outer peripheral portion
43 restriction ridge
44 the radially inner peripheral portion
50 spiral spring
51 lower large-diameter portion
110 fastening bolt

1. A shock absorber for connecting a vibration member as a vibration source and a covering member for covering the vibration member to absorb vibration from the vibration member to the covering member, the shock absorber comprising:
a collar including a substantially tubular collar shaft to be fastened to the vibration member with a fastener, and annular flanges protruding radially outward from two axial ends of the collar shaft;
an annular fixing member fixable to the covering member;
an annular shock absorbing member located between the collar and the fixing member with a radially outer peripheral portion of the shock absorbing member fixed to the fixing member, the shock absorbing member comprising a shock absorbing material; and
a spring located between at least one of the flanges on the collar and the shock absorbing member, and overlaid on the shock absorbing member,
wherein the shock absorbing member includes a radially inner peripheral portion loosely fitted on the collar shaft at least in a radial direction;
the spring has a spring constant equal to or smaller than a spring constant of the shock absorbing member, and is substantially truncated in a side view which has a larger diameter in a portion nearer the shock absorbing member than in a portion nearer the at least one of the flanges, and is spiral in a plan view;
the radially inner peripheral portion of the shock absorbing member is thicker than the radially outer peripheral portion fixed to the fixing member,
the shock absorbing member includes a movement restrictor in contact with the spring to restrict radial movement of the spring relative to the shock absorbing member,
the movement restrictor located between the radially inner peripheral portion and the radially outer peripheral portion, and is adjacent to the spring on the shock absorbing member;
the movement restrictor includes a movement restriction ridge protruding to outwardly more than the radially inner peripheral portion, and
extends along and is in contact with the radially outer portion that is radially outward in the spring spiral in a plan view
the spring has a radially outer portion in contact with 40% to 55% of a circumference of the movement restrictor.

2. The shock absorber according to claim 1, wherein
the thickness of the radially inner peripheral portion is twice of the one of radially outer peripheral portion fixed to the fixing member.

3. The shock absorber according to claim 1, wherein
the movement restriction ridge in contact with the radially outer portion located radially outward of the spring is an outwardly-curved cross section.

4. The shock absorber according to claim 1, wherein
the spring substantially truncated in a side view has a height greater than a distance between the shock absorbing member in contact with one of the flanges on the two axial ends and another of the flanges.

5. A metal cover, comprising:
the shock absorber according to claim 1 attached to a covering member for covering a vibration member.

6. The shock absorber according to claim 2, wherein
the movement restriction ridge in contact with the radially outer portion located radially outward of the spring is an outwardly-curved cross section.

7. A metal cover, comprising:
the shock absorber according to claim 2 attached to a covering member for covering a vibration member.

8. A metal cover, comprising:
the shock absorber according to claim 3 attached to a covering member for covering a vibration member.

9. A metal cover, comprising:
the shock absorber according to claim 4 attached to a covering member for covering a vibration member.

10. A metal cover, comprising:
the shock absorber according to claim 5 attached to a covering member for covering a vibration member.
